(19) United States
(12) Patent Application Publication
(10) Pub. No.: US 2018/0349989 A1
(43) Pub. Date: Dec. 6, 2018

(54) CREDIT DECISIONING SERVICE

(71) Applicant: LendingClub Corporation, San Francisco, CA (US)

(72) Inventors: Eddie Gonzales, Richmond, CA (US); Abhijit Karpe, Fremont, CA (US); Wira Pradjinata, Fremont, CA (US)

(21) Appl. No.: 15/614,046

(22) Filed: Jun. 5, 2017

(51) Int. Cl. G06Q 40/02; G06F 9/44

(52) U.S. Cl. CPC G06Q 40/025; H04L 51/02; G06F 8/315

(57) ABSTRACT

A method and system for authoring and publishing a future credit policy to a credit decisioning service. A future credit policy is generated in a statistical analysis formant and transformed into an executable code enhanced for credit decisioning. The future credit policy may be tested before deployment using credit decisioning service requests sent to the credit decisioning service using a current credit policy.

### TECHNICAL FIELD

The present application relates generally to electronic commerce and, in one specific example, to techniques for automating credit decisioning for ecommerce transactions.

### BACKGROUND

Network-based loan application services have become popular and available to virtually everyone. Accordingly, network-based loan services must necessarily provide an automated approach for approving or declining loan applications. The decision whether to approve or decline a loan application is based on a credit policy of the network-based loan service.

As not all approved and funded loan applicants are able or willing to continue to service (i.e., repay) the loan as agreed, the credit policy of the network-based loan service must continuously refine their credit policy. Accordingly, timely deploying a refined credit policy for making future loan application decisions becomes increasingly important to reduce risk of loss.

### BRIEF DESCRIPTION OF THE DRAWINGS

Some embodiments are illustrated by way of example and not limitation in the figures of the accompanying drawings in which:

FIG. 1 is a network diagram depicting a client-server system, within which one example embodiment may be deployed.

FIG. 2 is a block diagram illustrating a loan applicant user interface, credit decisioning service, loan servicing, and credit policy authoring and publishing applications that, in one example embodiment, are provided as part of application server(s) in a networked system.

FIG. 3 is a flow diagram illustrating an example flow of the credit policy authoring and publishing process, in accordance with an example embodiment.

FIG. 4 is an example statistical analysis system (SAS) file, in accordance with an example embodiment.

FIG. 5 is flow diagram of an example of the execution of the credit decisioning service (CDS) and credit policy testing, consistent with various embodiments.

FIG. 6 is a flowchart illustrating an example method, according to an example embodiment.

FIG. 7 is a flowchart illustrating an example method in a credit decisioning service, according to various embodiments.

FIG. 8 is a block diagram of a machine in the example form of a computer system within which instructions may be executed for causing the machine to perform any one or more of the methodologies discussed herein.

### DETAILED DESCRIPTION

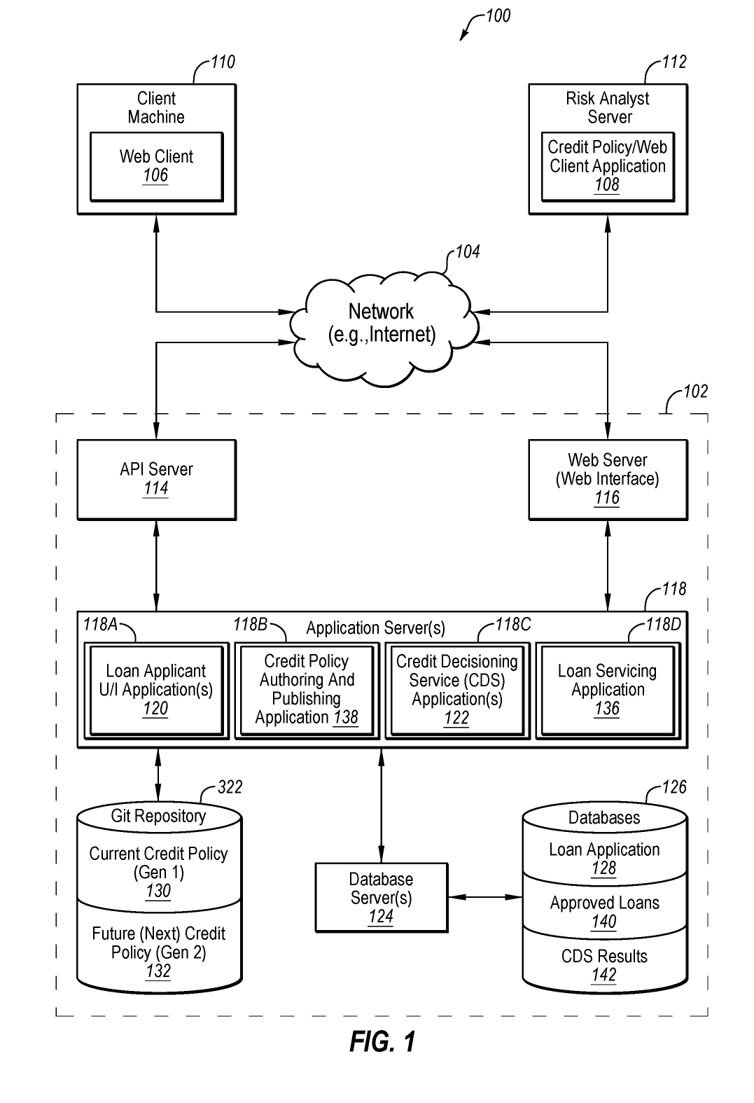

FIG. 1 is a network diagram depicting a client-server system 100, within which one example embodiment may be deployed. A networked system 102, in the example, forms a network-based loan servicing system and provides server-side functionality, via a network 104 (e.g., the Internet or a Wide Area Network (WAN)), to one or more clients. FIG. 1 illustrates, for example, a web client 106 (e.g., a browser, such as the Internet Explorer browser developed by Microsoft Corporation of Redmond, Wash. State) and a risk analyst server 112 including a programmatic client such as a credit policy application 108 for aiding in authoring and publishing a future credit policy.

An Application Program Interface (API) server 114 and a web server 116 are coupled to, and provide programmatic and web interfaces respectively to, one or more application servers 118. The application servers 118 host one or more loan applicant user interface applications 120, credit decisioning service (CDS) applications 122, and loan servicing applications 136. The application servers 118 also host a credit policy authoring and publishing application 138 configured to generate a future credit policy (GEN 2) as authored by a risk analyst interacting with the risk analyst server 112. The application servers 118 are, in turn, shown to be coupled to one or more database servers 124 that facilitate access to one or more databases 126.

Databases 126 may include a loan application database 128 configured to store loan application and applicant information, such as applicant identification for credit verification, loan purpose, loan amount, and loan term. Databases 126 may further include an approved loan database 140 configured to retain approved loans for funding and for servicing by loan servicing server 118D.

The networked system 102 may further include a source control management system like Git repository 322, which may provide storage and revision control for the statistical format credit policy (SAS code), the credit policy test data (CSV data), and the credit policy in computer-executable code (Java code). The Git repository 322 may provide ‘versioning’ and sharing capabilities by utilizing a version control system. The Git repository 322 may include a current credit policy (Gen 1) 130 and a future (next) credit policy (Gen 2) 132.

The loan applicant user interface application 120 may provide a number of user interface functions and services to users who access the networked system 102. The credit decisioning service application 122 may apply the current credit policy 130 to the specifics of a loan application in database 128 and provide a decision of whether to approve or decline the loan application and provide a reason for the decision. If approved, the loan application may be stored in the approved loans database 140 for further funding and servicing by loan servicing application 136.

The credit policy authoring and publishing application 138 provides development of a new or revised credit policy. The creation of a new credit policy includes authoring the credit policy and further includes publishing or deploying the credit policy.

Further, while the system 100 shown in FIG. 1 employs a client-server architecture, the embodiments are, of course, not limited to such an architecture, and could equally well find application in a distributed, or peer-to-peer, architecture system, for example. The various credit decisioning service application 122 and credit policy authoring and publishing application 138 could also be implemented as standalone software programs, which do not necessarily have networking capabilities.

The system 100 may be accessed by clients engaging in authoring and publishing credit policies and by clients using the credit policies for credit decisioning. The web client 106 accesses the loan applicant user interface application 120 via the web interface supported by the web server 116. The risk analyst server 112 accesses the various services and functions provided by the credit policy authoring and publishing application 138 via the programmatic interface provided by the API server 114. The credit policy application 108 may, for example, be an application to enable a risk analyst to generate a future credit policy in, for example, SAS code. Alternatively, the credit policy application 108 may be a web client such as web client 106 with all programmatic functionality being resident within the credit policy authoring and publishing application 138.

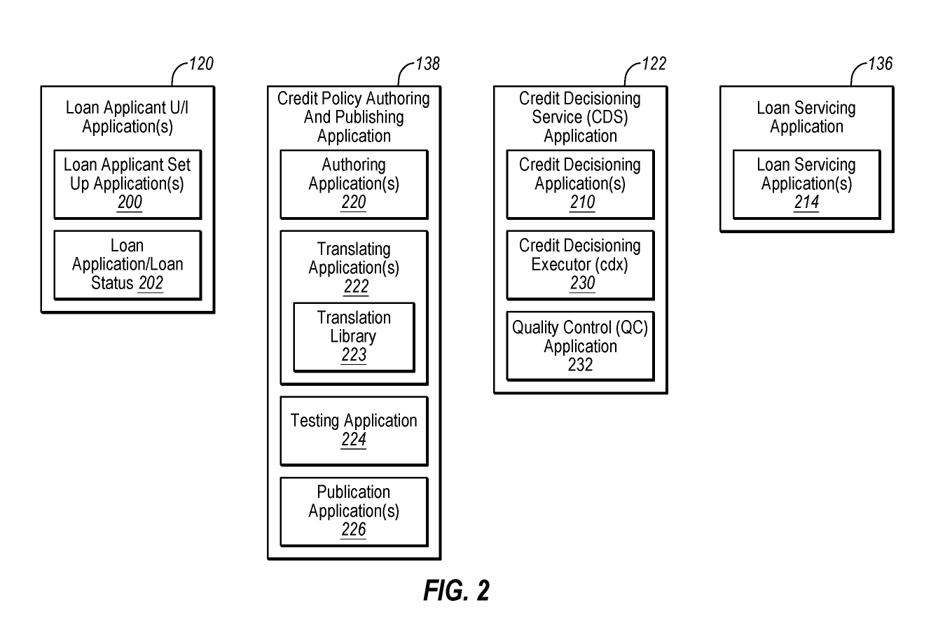

FIG. 2 is a block diagram illustrating a loan applicant user interface, credit decisioning service, loan servicing, and credit policy authoring and publishing applications 120, 122, 136, and 138 that, in one example embodiment, are provided as part of application server(s) 118 in the networked system 102. The applications 120, 122, 136, and 138 may be hosted on dedicated or shared server machines (not shown) that are communicatively coupled to enable communications between servers. The applications 120, 122, 136, and 138 themselves are communicatively coupled (e.g., via appropriate interfaces) to each other and to various data sources, to allow information to be passed between the applications 120, 122, 136, and 138 to allow the applications 120, 122, 136, and 138 to share and access common data. The applications 120, 122, 136, and 138 may furthermore access one or more databases 126 via the database servers 124.

The networked system 102 of FIG. 1 may provide a number of credit servicing mechanisms whereby loan applicants may submit a loan application, a network-based loan service may perform a credit decision on the loan application based on the current credit policy, and the network-based loan service may author a future credit policy and publish the future credit policy as a new current credit policy for use in future credit decisions on future loan applications.

The loan applicant user interface application 120 is shown to include a loan applicant set up application 200, which supports a user identification in the networked system 102. The loan applicant set up application 200 may include login, user identification, financial institution information, and user credit information. The above-set up information may be stored in the applicant's loan application database 128 of FIG. 1, as accessed via the database server(s) 124 also of FIG. 1.

The loan applicant user interface application 120 is shown to also include a loan application and status application 202, which may include the specifics regarding a specific loan application of a loan applicant. The loan application may include the desired loan amount, desired loan term, and purpose for the loan information allowing a loan applicant to access the networked system 102. Following a credit decision on the loan application, the status of the credit decision may also be stored in the applicant's loan application database 128 of FIG. 1, as accessed via the database server(s) 124 also of FIG. 1.

The networked system 102 further includes the credit decisioning service application 122, which makes a credit decision relating to a loan application based on the current credit policy. The credit decisioning service application 122 is shown to include a credit decisioning application 210, which may access both a loan application in the loan application database 128 and the current credit policy 130. Based on the loan application and the current credit policy, the credit decisioning application 210 may either approve or decline the loan application. The result of the credit decisioning may then be stored as a status to the loan application in the loan application database 128.

The credit decisioning service application 122 may further include a credit decisioning executor (cdx) application 230 for executing a request based on a version of the credit policy for the requested loan type. The credit decisioning executor (cdx) application 230 may use either a current credit policy (Gen 1) or a future credit policy (Gen 2) to generate a credit decision or result. The credit decisioning service application 122 may further include a quality control (QC) application 232 for running quality control scripts.

The networked system 102 further includes the loan servicing application 136, which may provide grading of the loan (i.e., high vs. low risk, etc.), funding of the loan via investors, and administering or servicing the loan through, for example, billing and collecting from a successful loan applicant. Further, the loan servicing application 136 may distribute proceeds from the collection of loan payments.

The networked system 102 further includes the credit policy authoring and publishing application 138, which automates the credit policy authoring and publishing process from authoring to execution and may include supporting auditing, quality control, and testing, including testing on historical back data. The credit policy authoring and publishing application 138 provides efficiencies to develop new or future credit policies through automated translation of a prospective credit policy authored in, for example, a statistical based language such as SAS. The translation of a statistical based language to a computer-executable language has traditionally required significant human input. The credit policy authoring and publishing application 138 provides an automated translation, for example, of SAS code into a computer-executable code such as Java.

Such automation may greatly improve the responsiveness of a credit service by allowing credit policies to be updated to reflect changes in the credit marketplace. Further, automation reduces human errors that can cause delays and create significant credit losses due to improper approval of loan applications or improperly applied interest rates. Further, since credit policies may be published or deployed based on an automated translation rather than being handed-off to others for execution code generation, the lifecycle of a credit policy may be administered by the same entity such as the credit policy authoring entity.

The credit policy authoring and publishing application 138 is shown to include an authoring application 220, which allows the generation of a new credit policy using a statistical based language. The authoring application 220 provides a web interface for a risk analysts to create or modify credit policies.

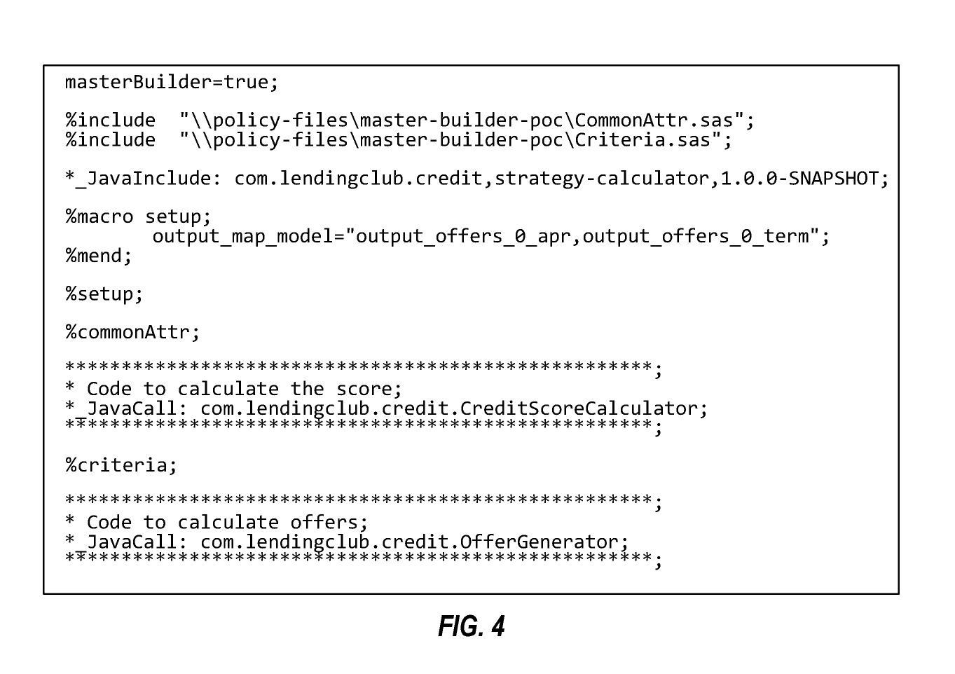

The credit policy authoring and publishing application 138 is shown to include a translating application 222, which allows the conversion from a credit policy written in a statistical based language into a credit policy in a computer-executable language. The translating application 222 may use Translation Libraries 223 to convert a credit policy written in a statistical language (e.g., SAS) to execution code (e.g., Java). The translating application 222 performs this function without manual error-prone intervention. The translating application 222 may include support for parser directives (ignored by any SAS program). The directive could be used for including and invoking specific Java libraries from SAS during translation. For instance, the fourth line in FIG. 4 (*_JavaInclude: com.lendingclub.credit,strategy-calculator,1.0.0-SNAPSHOT;) is a parser directive to incorporate a Java library called, for example, “strategy-calculator” with a specific version (1.0.0-SNAPSHOT) from a Maven repository (such as Artifactory). This library may then be used in line 10 (*_JavaCall: com.lendingclub.credit.CreditScoreCalculator;). In this line for example, a Java class inside the incorporated library called, for example, CreditScoreCalculator may be invoked to calculate credit score and produce an output that can be used by the rest of the SAS code.

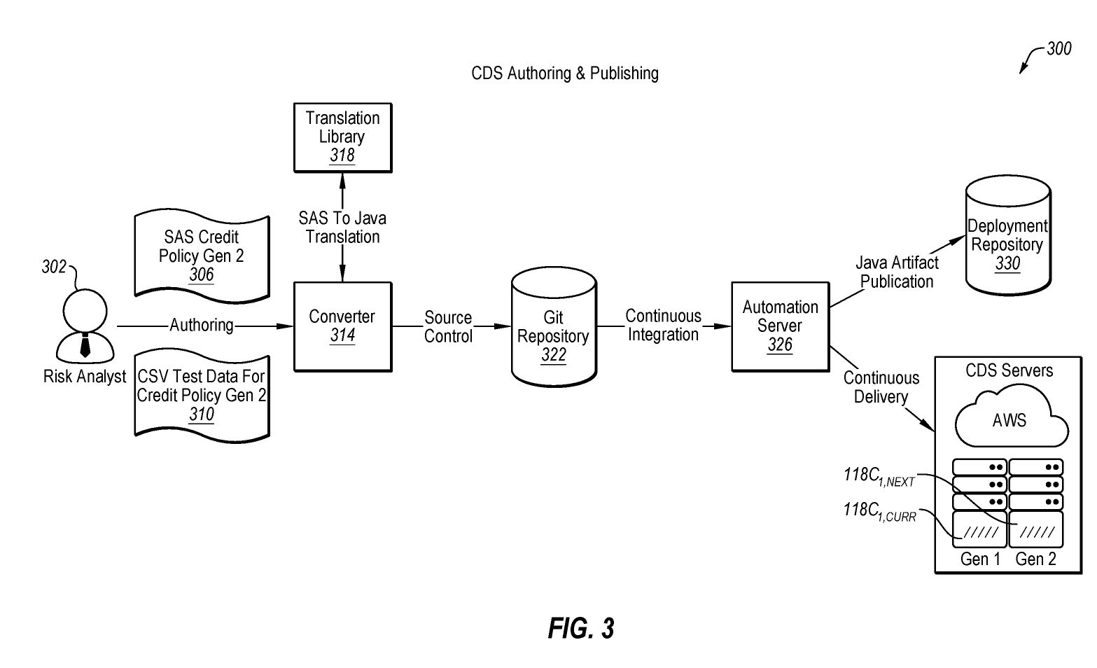

Further, the translating application 222 may further include a Maven plugin utilized as a part of the build process as further described below with at least reference to a credit policy authoring and publishing process 300 of FIG. 3. The translating application 222 may further generate unit tests to support step the testing application 224 as further described below. Yet further, the translating application 222 may directly map SAS variables to and from JSON elements. The variables may be subsequently translated into Java Map keys. For example, a JSON payload

Sample JSON

{

“input”: {

“collateralInfo”: {

“vehicleInfo”: {

“year”: 2016,
“make”: “Honda”,
“model”: “Odyssey”

}

}

}

}

may be difficult to use by a typical SAS program. The application 222 may automatically map the first element (the year of the vehicle in the collateral section of the input) into a SAS variable called “input-collateralInfo-vehicleInfo-year” with a value of “2016”, which appears to SAS as a regular variable instead of a hierarchical JSON structure. The variable “input-collateralInfo-vehicleInfo-year” becomes a Map key in the translated Java code with the same value of “2016”.

The translating application 222 may further provide a modular template for creating credit policy components with an architecture that may further produce not just Java, but also other languages such as Python and html.

The credit policy authoring and publishing application 138 is shown to include a testing application 224, which allows verification of the translation of the new credit policy prior to publication of the new credit policy. The testing application 224 requires the user to provide test cases that validate the logic of the credit policy code written in statistical language. These test cases may be provided in a plain text file like a .CSV file (310 in FIG. 3). The testing application then automatically creates unit tests based on the test file provided by the user, which may reduce QA effort and provides feedback to the user about the correctness of the credit policy code. The testing application 224 may also call the credit decisioning executor (cdx) 230 in the credit decisioning service application 122 to execute the new credit policy (Gen 2). Further, the testing application 224 may further call the quality control (QC) application 232 in the credit decisioning service application 122 to perform quality analysis of the new credit policy.

The credit policy authoring and publishing application 138 is shown to include a publication application 226, which allows the translated credit policy to be delivered for execution by the credit decisioning service application 122 for use in either approving or declining loan applications. The publishing application 226 may publish the converted executable source code to a source control system like a GIT repository 322, further described herein. The publishing application 226 may further compile the source code to machine executable code and may publish the machine executable code to an artifact repository management system illustrated herein as a deployment repository 330 of FIG. 3, an example of which may be the open-source Artifactory. The publishing application 226 may also allow risk analysts to quickly iterate on the new credit policy, which may reduce, for example, operational overhead by automating deployment.

FIG. 3 is a flow diagram illustrating an example flow of the credit policy authoring and publishing process 300, consistent with various embodiments. Process 300 may include a risk analyst which provides inputs or otherwise programs a credit policy based on various factors in the generation of a next-generation (future) credit policy 306 that is to be followed in the evaluation process for loan applications. The process 300 may include a risk analyst 302 authoring a next-generation credit policy 306 in a statistical language such as in SAS code. A risk analyst may utilize credit bureau and other associated data to predict the probability of default and set thresholds for accepting applications when testing a newly revised credit policy.

The risk analyst 302 may also generate test data 310 for evaluation or testing of the next-generation credit policy 306. The test data 310 may be provided in a comma separated value (CSV) file which may contain inputs and expected outputs to validate the result of the policy. The policy test code 306 may contain various conditions and variations of variables for anaylzing the next-generation credit policy 306. Testing of the next-generation credit policy 306 using the policy test code 306 attempts to establish the validity of the next-generation credit policy 306.

Process 300 further includes a converter 314 configured to receive a credit policy in a statistical format, for example SAS code, and generate the credit policy in an executable format, for example Java code. The converter 314 may be configured as one or more processors configured by software (e.g., an application or application portion) or as a hardware-implemented module that operates to perform certain operations as described herein. The converter is not just a standard translation engine because it is capable of mixing and matching multiple languages. One possible example would be SAS code and Java code being combined into one credit policy code.

The converter 314 may be coupled to a translation library 318 which may include lexical rules or other translation instructions for generating the credit policy in an executable format from the credit policy in a statistical language format.

The converter 314 may be configured to parse the SAS code and may use the translation library 318 when the converter 314 encounters SAS code.

The converter 314 may be configured to translate the SAS code to Java source code. The converter consults the translation library 223 for each line of SAS code encountered by the converter 314.

The converter 314 may be configured to enhance the translated Java code into credit decisioning Java code. There may be non-functional requirements associated with credit decisioning, such as auditing and integrating with external systems or dependencies, including existing calculation logic. The enhancements of the Java code allow seamless integration with the credit decisioning service application 122.

The converter 314 may be configured to perform data-driven testing of the credit policy in the credit decisioning Java code. As stated, the test data 310 for the new credit policy includes inputs for the new credit policy and expected outputs for the new credit policy, utilizing the test data 310.

The converter 314 may be configured to provide feedback for the test results from the data-driven testing and the CSV testing. The converter either points out the errors or provides green light when the generated code produces the expected output.

The credit policy authoring and publishing process 300 may further include a source control management system like Git repository 322, which may provide storage and revision control for the statistical format credit policy (SAS code), the credit policy test data (CSV data), and the credit policy in computer-executable code (Java code). The Git repository 322 may provide ‘versioning’ and sharing capabilities by utilizing a version control system.

The credit policy authoring and publishing process 300 may further include an automation server 326 which may be configured to automate portions of the software-development process. In one example, the automation server 326 may be configured according to the open source Jenkins server. The automation server 326 may perform functions such as continuous integration for building and testing the checked-in Java code. The automation server 326 may continuously build the next-generation credit policy as the policy may be iteratively developed.

The credit policy authoring and publishing process 300 may further include a deployment artifact repository 330 which may receive Java artifacts for publication. The repository 330 may store versioned snapshots of a credit policy, which may be in the form of a Java library, micro-service, or web application. The generated web service deliverables from the automation sever may be published into the deployment artifact repository 330 to be picked up by a deployment process.

The credit policy authoring and publishing process 300 may further include cloud-based web services 334, an example of which may be Amazon Web Services (AWS) or similar web services. The web services 334 may also be illustrated as a networked system 102 including a current credit policy (GEN 1) 130 running in a credit decision executor server 118C_{1,CURR} and a future or next credit policy (GEN 2) 132 running in a credit decision executor server 118C_{1,NEXT}. The deliverables in the deployment artifact repository 330 may be picked up and deployed into a cluster of credit decisioning executors, with each cluster executing a particular credit policy.

FIG. 4 is an example SAS file, consistent with various embodiments. The example SAS file may include instructions to invoke Java code in between SAS code. For example, the example SAS file may include other SAS modules to be wired together, or a Java library dependency, or a call to execute a SAS macro or a Java class. The SAS file may further illustrate how to assemble a credit policy along with its building blocks.

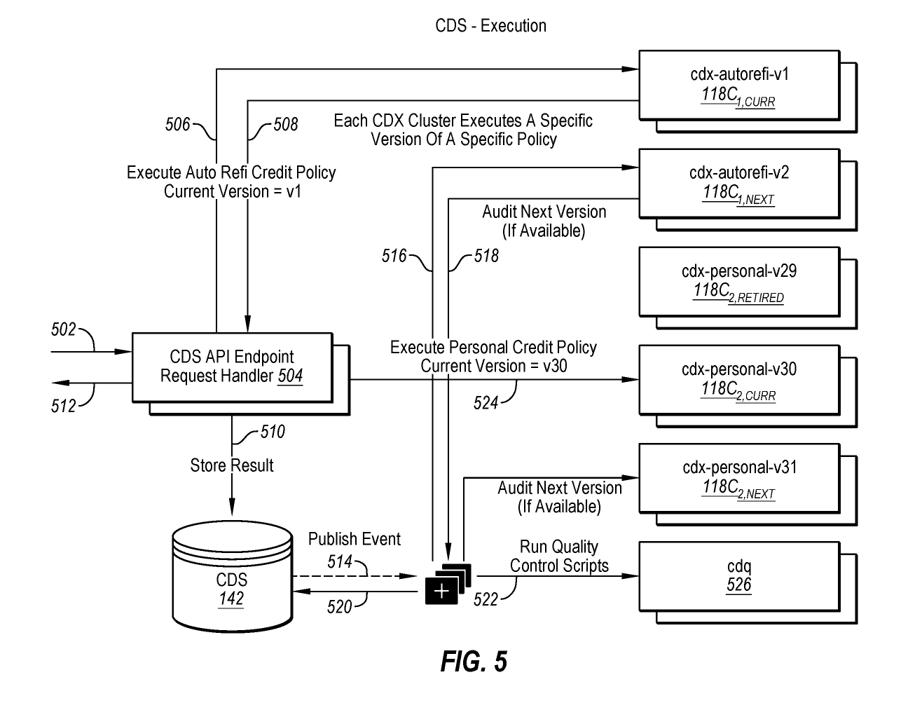

FIG. 5 is flow diagram of an example of the execution of the credit decisioning service (CDS) and credit policy testing, consistent with various embodiments. A CDS request 502 may be received as an API call to, for example, API server 114 of FIG. 114 of FIG. 1 which may include a request handler 504. The request handler 504 identifies a loan type from the request and determines a current version of the credit policy for the requested loan type from databases 126 of FIG. 1. Each loan type may be executed on dedicated CDS servers (CDX) 118Cₓ or they may be executed on a shared server. FIG. 5 illustrates dedicated servers for each credit policy version for each type of loan. For example, CDS server 118C_{1,CURR} executes the credit decisioning service application 210 for auto refinance loan applications using the current version of the auto refinancing credit policy. CDS server 118C_{1,NEXT} executes the credit decisioning service application for auto refinance loan applications using the next or future version of the auto refinancing credit policy. CDS server 118C_{2,RETIRED} no longer executes the credit decisioning service application for personal loan applications since the retired version of the personal loan credit policy has been retired. CDS server 118C_{2,CURR} executes the credit decisioning service application for personal loan applications using the current version of the personal loan credit policy. CDS server 118C_{2,NEXT} executes the credit decisioning service application for personal loan applications using the next or future version of the personal loan credit policy.

The request handler 504 determines the CDS request 502 was for an auto refinance loan type and the current version of the credit policy for the auto refinance loan application is, for example, “v1” executing on the CDS server 118C_{1,CURR}. Accordingly, the request handler 504 issues a request 506 to the CDS server 118C_{1,CURR} requesting a credit decision based on the current or deployed version of the credit policy for auto refinance loan applications. In response, the CDS server 118C_{1,CURR} generates a CDS result and returns the CDS result in a response 508 to the request handler 504. The request handler 504 stores 510 the CDS result in the CDS results database 142. The request handler 504 issues a response 512 of the CDS result to the API server 114.

In response to the CDS persisting result stored in 510, asynchronous event 514 may be published. Based on the audit configuration for 118C_{1,CURR}, request 516 may be issued in an audit mode to the CDS server 118C_{1,NEXT} requesting a credit decision based on the next version of the credit policy for auto refinance loan applications. In response 518, the CDS server 118C_{1,NEXT} generates a CDS result and stores the result in database 142 via 520. The CDS result may also be sent or trigger execution 522 of quality control scripts in a credit decision quality control server 526.

FIG. 5 further illustrates the request handler 504 responding to a CDS request for a personal loan type. The CDS server 118C_{2,CURR} executes the credit decisioning service application 210 for personal loan applications using the current version of the personal loan credit policy. The CDS server 118C_{2,NEXT} executes the credit decisioning service application for personal loan applications using the next or future version of the personal loan credit policy.

The current version of the credit policy for a personal loan application is, for example, “v30” executing on the CDS server 118C_{2,CURR}. Accordingly, the request handler 504 issues a request 524 to the CDS server 118C_{2,CURR} requesting a credit decision based on the current or deployed version of the credit policy for personal loan applications. In response, the CDS server 118C_{2,CURR} generates a CDS result (not shown for clarity) and returns the CDS result in a response to the request handler 504. The request handler 504 stores the CDS result in the CDS results database 142. The request handler 504 issues a response of the CDS result into the API server 114.

Further as with the auto refinance example described above, in response to CDS persisting result in 510, a request may be issued in an audit mode to the CDS server 118C_{2,NEXT} requesting a credit decision based on the next version of the credit policy for personal loan applications. In response, the CDS server 118C_{2,NEXT} generates a CDS result and stores the result in database 142 via 520. The CDS result may also be sent to or trigger execution of quality control scripts in a credit decision quality control server 526 and stores the result in database 142.

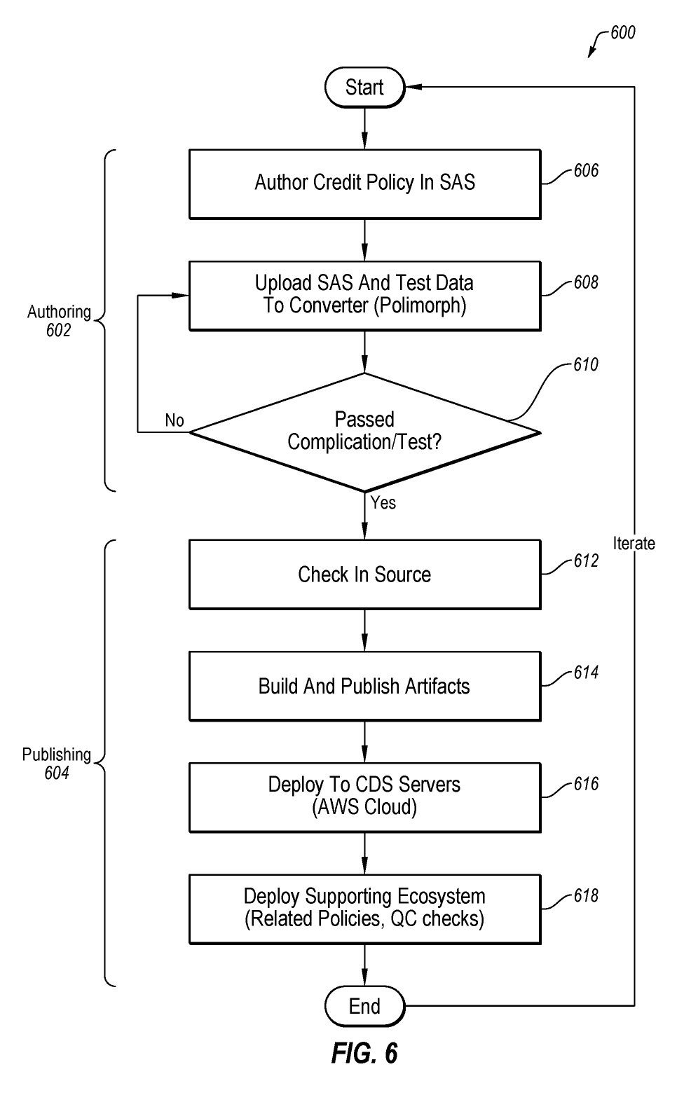

FIG. 6 is a flowchart illustrating an example method 600, consistent with various embodiments. The credit policy authoring and publishing method 600 may include an authoring phase 602 and a publication phase 604. The method may be performed in the credit policy authoring and publishing application 138.

At a step 606, a risk analyst may author a credit policy in a statistical language such as SAS. The credit policy may be specific to a type of loan such as an auto refinance loan, a personal loan, or other categories of loans that form a part of the loan service. The SAS code file may be similar to the SAS code file illustrated in FIG. 4.

At a step 608, the SAS code 306 and the test data 310 of FIG. 3 may be uploaded to the converter 314 which may be a user interface to a web-based credit decision authoring user interface. The converter 314 also references a translation library 318 used to translate the SAS code of the future credit policy into Java code of the future policy.

A query step 610 determines if the translation or compilation passed based on tests as specified above with respect to FIG. 3. If the translation or compilation did not pass, then processing returns to step 608. It should be noted that failures may be caused by coding, test data, or translation errors, which need to be resolved before continuing. If the translation or compilation passes, then processing moves to the publishing phase 604.

At a step 612, the Java source code may be checked in to a GIT repository 322, which may provide storage and revision control for the statistical format of a future credit policy (SAS code), the credit policy test data (CSV data) for the future credit policy, and the future credit policy in computer-executable code (Java code).

At a step 614, the Java code undergoes a build and publication of artifacts in an automation server 326 and automates portions of the software-development process. In one example, the automation server 326 may be configured according to the open source Jenkins server. The automation server 326 may perform functions such as continuous integration for building and testing the checked-in Java code.

At a step 616, the published Java code may be deployed to the web services, an example of which may be Amazon Web Services (AWS) or other services including dedicated web services. Deployment may be in conjunction with a deployment artifact repository 330 which may receive Java artifacts for publication. The generated web service deliverables from the automation server may be published into the deployment artifact repository 330 to be picked up by a deployment process.

Throughout the development life cycle, the users, such as the risk analyst, may iteratively test, fine-tune, and deploy the credit policy until it meets expectations. If necessary, the credit policy can run in production in audit mode, which enables the users, such as the risk analyst, to analyze the result of the future credit policy being developed without impacting real-time credit decisioning of loan applications.

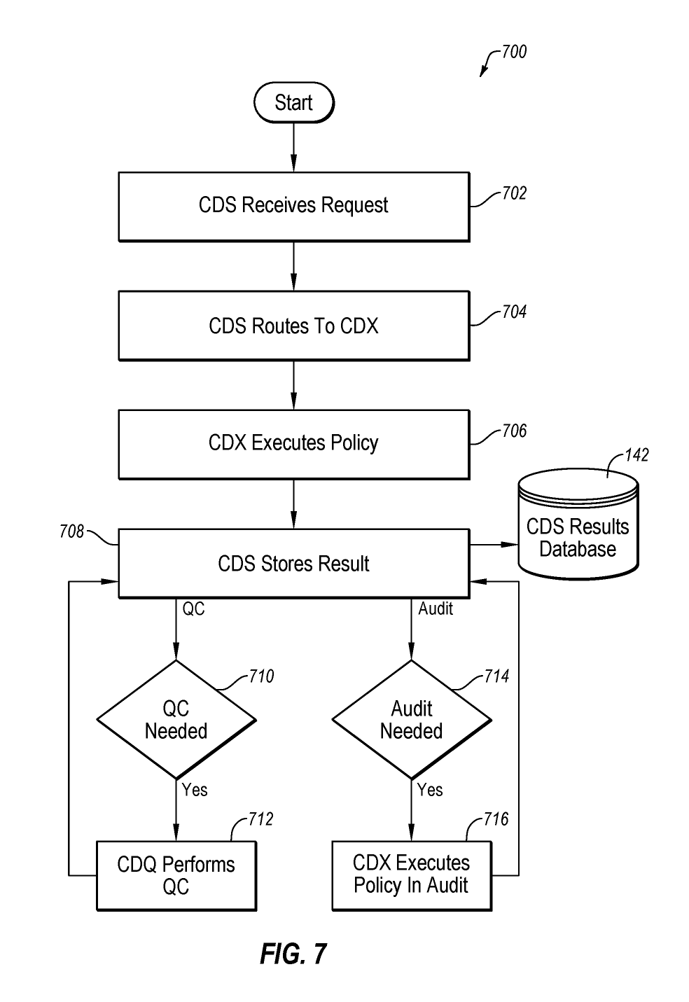

FIG. 7 is a flowchart illustrating an example method 700, consistent with various embodiments. The credit decisioning service method 700 may be performed in the credit decisioning service application 122.

At a step 702, the request handler 504 of FIG. 5 receives a CDS request identifying a loan type from the request and determines a current version of the credit policy for the requested loan type from databases 126 of FIG. 1.

At a step 704, the request handler 504 of the credit decisioning service routes the CDS request to a CDS server 118C configured to execute the credit decisioning service application 210 for loan applications, or type of loan application, using the current version of the credit policy.

In a step 706, the CDS server 118C executes the current credit policy on the CDS request and generates a CDS result and returns the CDS result in a response to the request handler 504.

In a step 708, the request handler 504 stores the CDS result in the CDS results database 142.

A query step 710 determines if quality control (QC) scripts are configured, and if so, a step 712 executes the quality control scripts in a credit decision quality control server 526 and stores results in the CDS results database 142.

A query step 714 determines if an audit is needed, and if so, a step 716 executes the audit process and stores the results in the CDS results database 142.

Certain embodiments are described herein as including logic or a number of components, modules, or mechanisms. Modules may constitute either software modules (e.g., code embodied (1) on machine-readable storage or (2) in a transmission signal) or hardware-implemented modules. A hardware-implemented module is a tangible unit capable of performing certain operations and may be configured or arranged in a certain manner. In example embodiments, one or more computer systems (e.g., a standalone, client or server computer system) or one or more processors 802 may be configured by software (e.g., an application or application portion) as a hardware-implemented module that operates to perform certain operations as described herein.

In various embodiments, a hardware-implemented module may be implemented mechanically or electronically. For example, a hardware-implemented module may comprise dedicated circuitry or logic that is permanently configured (e.g., as a special-purpose processor, such as a field programmable gate array (FPGA) or an application-specific integrated circuit (ASIC)) to perform certain operations. A hardware-implemented module may also comprise programmable logic or circuitry (e.g., as encompassed within a general-purpose processor or other programmable processor) that is temporarily configured by software to perform certain operations. It will be appreciated that the decision to implement a hardware-implemented module mechanically, in dedicated and permanently configured circuitry, or in temporarily configured circuitry (e.g., configured by software) may be driven by cost and time considerations.

Accordingly, the term “hardware-implemented module” should be understood to encompass a tangible entity, be that an entity that is physically constructed, permanently configured (e.g., hardwired) or temporarily or transitorily configured (e.g., programmed) to operate in a certain manner and/or to perform certain operations described herein. Considering embodiments in which hardware-implemented modules are temporarily configured (e.g., programmed), each of the hardware-implemented modules need not be configured or instantiated at any one instance in time. For example, where the hardware-implemented modules comprise a general-purpose processor configured using software, the general-purpose processor may be configured as respective different hardware-implemented modules at different times. Software may accordingly configure processor 602, for example, to constitute a particular hardware-implemented module at one instance of time and to constitute a different hardware-implemented module at a different instance of time.

Hardware-implemented modules can provide information to, and receive information from, other hardware-implemented modules. Accordingly, the described hardware-implemented modules may be regarded as being communicatively coupled. Where multiple of such hardware-implemented modules exist contemporaneously, communications may be achieved through signal transmission (e.g., over appropriate circuits and buses that connect the hardware-implemented modules). In embodiments in which multiple hardware-implemented modules are configured or instantiated at different times, communications between such hardware-implemented modules may be achieved, for example, through the storage and retrieval of information in memory structures to which the multiple hardware-implemented modules have access. For example, one hardware-implemented module may perform an operation, and store the output of that operation in a memory device to which it is communicatively coupled. A further hardware-implemented module may then, at a later time, access the memory device to retrieve and process the stored output. Hardware-implemented modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or more processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., application program interfaces (APIs).)

Example embodiments may be implemented in digital electronic circuitry, or in computer hardware, firmware, software, or in combinations of them. Example embodiments may be implemented using a computer program product, e.g., a computer program tangibly embodied in an information carrier, e.g., in a machine-readable medium for execution by, or to control the operation of, data processing apparatus, e.g., a programmable processor, a computer, or multiple computers.

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors 802 executing a computer program to perform functions by operating on input data and generating output. Method operations can also be performed by, and apparatus of example embodiments may be implemented as, special purpose logic circuitry, e.g., a field programmable gate array (FPGA) or an application-specific integrated circuit (ASIC).

The computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that that both hardware and software architectures merit consideration. Specifically, it will be appreciated that the choice of whether to implement certain functionality in permanently configured hardware (e.g., an ASIC), in temporarily configured hardware (e.g., a combination of software and a programmable processor 802), or a combination of permanently and temporarily configured hardware may be a design choice. Below are set out hardware (e.g., machine) and software architectures that may be deployed, in various example embodiments.

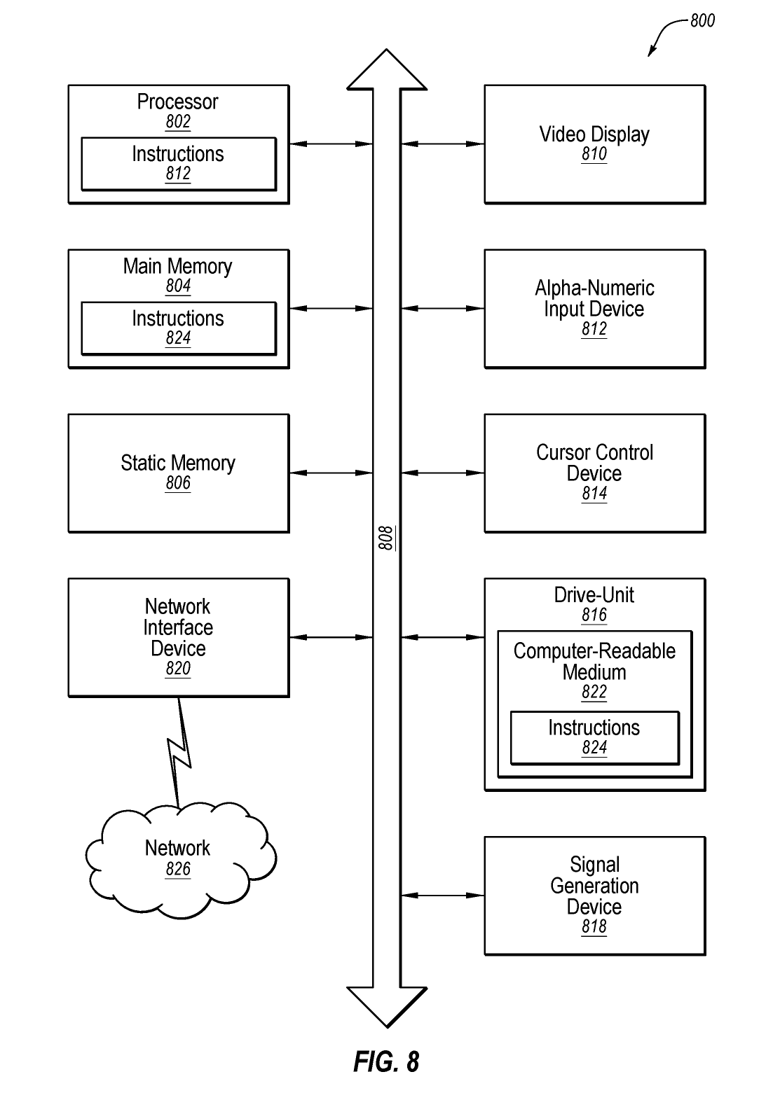

FIG. 8 is a block diagram of a machine in the example form of a computer system 800 within which instructions 824 may be executed for causing the machine to perform any one or more of the methodologies discussed herein. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a personal digital assistant (PDA), a cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 800 includes a processor 802 (e.g., a central processing unit (CPU), a graphics processing unit (GPU) or both), a main memory 804 and a static memory 806, which communicate with each other via a bus 808. The computer system 800 may further include a video display unit 810 (e.g., a liquid crystal display (LCD) or a cathode ray tube (CRT)). The computer system 800 also includes an alphanumeric input device 812 (e.g., a keyboard or a touch-sensitive display screen), a user interface (UI) navigation (e.g., cursor control) device 814 (e.g., a mouse), a disk drive unit 816, a signal generation device 818 (e.g., a speaker) and a network interface device 820.

The disk drive unit 816 includes a computer-readable medium 822, which may be hardware storage, on which is stored one or more sets of data structures and instructions 824 (e.g., software) embodying or utilized by any one or more of the methodologies or functions described herein. The instructions 824 may also reside, completely or at least partially, within the main memory 804 and/or within the processor 802 as instructions 812 during execution thereof by the computer system 800, the main memory 804 and the processor 802 also constituting computer-readable media 822.

While the computer-readable medium 822 is shown in an example embodiment to be a single medium, the term “computer-readable medium” may include a single medium or multiple media (e.g., a centralized or distributed database, and/or associated caches and servers) that store the one or more instructions 824 or data structures. The term “computer-readable medium” shall also be taken to include any tangible medium that is capable of storing, encoding or carrying instructions 824 for execution by the machine and that cause the machine to perform any one or more of the methodologies of the present disclosure or that is capable of storing, encoding or carrying data structures utilized by or associated with such instructions 824. The term “computer-readable medium” shall accordingly be taken to include, but not be limited to, solid-state memories, and optical and magnetic media. Specific examples of computer-readable media 822 include non-volatile memory, including by way of example semiconductor memory devices, e.g., erasable programmable read-only memory (EPROM), electrically erasable programmable read-only memory (EEPROM), and flash memory devices; magnetic disks such as internal hard disks and removable disks; magneto-optical disks; and CD-ROM and DVD-ROM disks.

The instructions 824 may further be transmitted or received over a communications network 826 using a transmission medium. The instructions 824 may be transmitted using the network interface device 820 and any one of a number of well-known transfer protocols (e.g., HTTP). Examples of communication networks include a local area network (“LAN”), a wide area network (“WAN”), the Internet, mobile telephone networks, plain old telephone (POTS) networks, and wireless data networks (e.g., WiFi and WiMax networks). The term “transmission medium” shall be taken to include any intangible medium that is capable of storing, encoding or carrying instructions 824 for execution by the machine, and includes digital or analog communications signals or other intangible media to facilitate communication of such software.

Although the inventive subject matter has been described with reference to specific example embodiments, it will be evident that various modifications and changes may be made to these embodiments without departing from the broader spirit and scope of the disclosure. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

1. A method, comprising:
authoring a future credit policy by transforming a future credit policy generated in a statistical analysis service (SAS) format into a future credit policy in Java code; and
publishing the future credit policy in Java code as a current credit policy used in a credit decisioning service of a loan application.

2. The method of claim 1, wherein the authoring comprises:
generating the future credit policy in the SAS format; and
transforming the future credit policy from the SAS format to the Java code using a library configured for credit decisioning.

3. The method of claim 1, wherein the authoring further comprises:
receiving test data for verification of the future credit policy in Java code; and
testing the future credit policy in Java code using the test data.

4. The method of claim 1, wherein the publishing further comprises:
deploying the future credit policy in Java code to a future credit policy server in a credit decisioning service concurrently operating with a current credit policy server configured to generate a current credit policy result in the credit decisioning service in response to a credit decisioning service request based on the loan application.

5. The method of claim 4, wherein the publishing further comprises:
testing the future credit policy in Java code including generating a future credit policy result in response to the credit decisioning service request based on the loan application.

6. The method of claim 4, wherein the publishing further comprises:
testing the future credit policy in Java code including generating at least one future credit policy result in response to at least one quality control script.

7. The method of claim 4, wherein the future credit policy server is used as the current credit policy server and the response to the credit decisioning service request based on the loan application is based on the future credit policy.

8. A non-transitory machine-readable storage medium embodying instructions that, when executed by a machine, cause the machine to perform operations comprising:
authoring a future credit policy by transforming a future credit policy generated in a statistical analysis service (SAS) format into a future credit policy in Java code; and
publishing the future credit policy in Java code as a current credit policy used in a credit decisioning service of a loan application.

9. The non-transitory machine-readable storage medium of claim 8, wherein the operations for authoring comprise:
generating the future credit policy in the SAS format; and
transforming the future credit policy from the SAS format to the Java code using a library configured for credit decisioning.

10. The non-transitory machine-readable storage medium of claim 8, wherein the operations for authoring further comprises:
receiving test data for verification of the future credit policy in Java code; and
testing the future credit policy in Java code using the test data.

11. The non-transitory machine-readable storage medium of claim 8, wherein the operations for publishing further comprises:
deploying the future credit policy in Java code to a future credit policy server in a credit decisioning service concurrently operating with a current credit policy server configured to generate a current credit policy result in the credit decisioning service in response to a credit decisioning service request based on the loan application.

12. The non-transitory machine-readable storage medium of claim 11, wherein the operations for publishing further comprises:
testing the future credit policy in Java code including generating a future credit policy result in response to the credit decisioning service request based on the loan application.

13. The non-transitory machine-readable storage medium of claim 11, wherein the operations for publishing further comprises:
testing the future credit policy in Java code including generating at least one future credit policy result in response to at least one quality control script.

14. The non-transitory machine-readable storage medium of claim 11, wherein the future credit policy server is used as the current credit policy server and the response to the credit decisioning service request based on the loan application is based on the future credit policy.

15. A system, comprising:
a credit policy authoring and publishing server configured to:
author a future credit policy by transforming a future credit policy generated in a statistical analysis service (SAS) format into a future credit policy in Java code; and
publish the future credit policy in Java code as a current credit policy used in a credit decisioning service of a loan application; and
a credit decisioning service server configured to:
generate a current credit policy result in response to a credit decisioning service request based on the loan application.

16. The system of claim 15, wherein the credit policy authoring and publishing server is configured to:
generate the future credit policy in the SAS format; and
transform the future credit policy from the SAS format to the Java code using a library configured for credit decisioning.

17. The system of claim 15, wherein the credit policy authoring and publishing server is further configured to:
receive test data for verification of the future credit policy in Java code; and
test the future credit policy in Java code using the test data.

18. The system of claim 15, wherein the credit policy authoring and publishing server is further configured to:
deploy the future credit policy in Java code to a future credit policy server in a credit decisioning service concurrently operating with a current credit policy server configured to generate a current credit policy result in the credit decisioning service in response to a credit decisioning service request based on the loan application.

19. The system of claim 18, wherein the credit policy authoring and publishing server is further configured to:
test the future credit policy in Java code including generating a future credit policy result in response to the credit decisioning service request based on the loan application.

20. The system of claim 15, wherein the credit policy authoring and publishing server is further configured to:
test the future credit policy in Java code including generating at least one future credit policy result in response to at least one quality control script.
